(19) United States
(12) Patent Application Publication
(10) Pub. No.: US 2009/0247346 A1
(43) Pub. Date: Oct. 1, 2009

(54) Two speed planetary electric shift gearbox

(75) Inventors: Dusan J. Hvolka, Salt Lake City, UT (US); Patrick Hvolka, Salt Lake City, UT (US); Viliam Raffaj, Salt Lake City, UT (US)

Correspondence Address: MARCUS G THEODORE, PC, 466 SOUTH 500 EAST, SALT LAKE CITY, UT, 84102, US

(73) Assignee: DJH Engineering Center, Inc.

(21) Appl. No.: 12/079,107

(22) Filed: Mar. 25, 2008

(51) Int. Cl. F16H 48/06

(52) U.S. Cl. 475/155

(57) ABSTRACT

A direct drive electric shift two speed planetary gearbox using a linear actuator to engage selectively planet, sun and ring gears to provide a low speed mode, a neutral mode, and a high speed mode of operation with significant fuel efficiencies.

### BACKGROUND OF THE INVENTION

1. Field

The present invention relates generally to gearboxes, and more particularly, to a direct drive electric shift two speed planetary gearbox using a linear actuator to engage selectively planet gears to provide a low speed mode, a neutral mode, and a high speed mode of operation with significant fuel efficiencies.

2. State of the Art

A number of gearboxes and transmission wheel hubs are known. For example, applicant's pending Two Speed Gearbox, Hvolka et al, patent application filed on Aug. 26, 2006 and assigned Ser. No. 11/510,024 provides a gearbox for driving high speed vehicles under high temperature operating conditions, and other devices which require variable operating two speed bearing thrust. It has an hydraulically activated dual clutch shift two speed planetary gearbox, which requires a pump, friction plates and cooling system, which result in efficiency losses.

Pitts, Hvolka et al, U.S. Pat. No. 6,935,986 B2, dated Aug. 30, 2005 discloses another two speed Gear Box. The Pitts/Hvolka et al Two Speed Gear Box axial force hydraulically developed by the piston is transmitted to the high speed clutch by a large ball bearing. On the other side of the gear box, the piston is supported by another ball bearing. This Pitts/Hvolka et al design is suitable for 150 horsepower operation. Operation of Pitts/Hvolka et al for long periods at 400 horsepower in the high speed mode shifts the entire gearing assembly against the thrust bearing shown in FIG. 1 overloading the bearing by the axial force. This causes added wear and heat buildup which unfavorably influences the bearing service life and reliability of this 2-speed gear box. The new design described below provides an improved Two Speed Gear Box capable of operating more like a transmission at higher horsepower and high speeds in climates where the temperatures routinely exceed 100 degrees.

Buuck et al., U.S. Pat. No. 5,478,290 dated Dec. 26, 1995 discloses a two speed high shift transmission residing within a rotatable wheel hub. It has dual hydraulic clutches to activate select gears of a planetary gear set including a first sun gear, a first planet gear, a first planet carrier and an inner ring gear. The first planet carrier includes a gear, which drives a second planetary gear set resulting in rotation of a wheel hub. When the first clutch is engaged, the inner ring gear is locked to a stationary outer ring effecting a high ratio reduction. When pressure to the first clutch is removed and applied to the second clutch, said first clutch disengages and said second clutch engages the sun gear and the planet carrier locking them together so that the sun gear, planet gear and planet carrier and inner ring gear rotate in unison effecting a low ratio reduction. Buuck et al may also incorporate a second planetary gear system operably associated with the hub to be selectively be engaged. The Buuck invention requires exterior dynamic seals, which are subject to leakage, and is subject to large clutch or brake forces exerted upon rotary bearings. This requires large design of the transmission and bearings to withstand such clutch and brake forces

Blanchard, U.S. Pat. No. 4,331,432 dated May 25, 1982 discloses a two speed automatic transmissions for marine propulsion. It employs an hydraulically actuated two speed transmission with a single fluid multi-pressure actuated clutch for activating different output shafts.

Brandt et al, U.S. Pat. No. 5,006,100 dated Apr. 9, 1991 discloses a two-speed planetary gear mechanism employing an hydraulically actuated piston to activate the ring gear of a planetary gear system in either one or two directions. It does not employ a clutch for smoother operation.

Neison, U.S. Pat. No. 6,350,165B1 dated Feb. 26, 2002 discloses a marine stem drive two-speed automatic transmission employing a planetary gear apparatus including two hydraulic clutches and a ring gear brake to provide two forward drive ratios, a reverse ratio, or a neutral ratio. In another embodiment, a third hydraulic clutch is included with bevel gears alone to provide two forward and reverse speeds.

Legner, U.S. Pat. No. 5,509,860 dated Apr. 23, 1996 discloses a power shift two-speed epicyclical gear box employing two hydraulically engaged friction clutches, which are alternatively engaged and disengaged by the force exerted by plate springs or hydraulic pistons. An accumulator and a check valve system are associated with the pressure chambers of the friction clutches to improve the shifting quality, particularly when downshifted from second to first gear.

Ahlen, U.S. Pat. No. 4,178,814 Dec. 18, 1979 discloses a two-speed gear transmission employing a direct drive connectable clutch wherein the input and output shafts rotate together and a second gear drive namely overdrive or under drive have one of the sun or ring hears held stationary by a brake relative to the casing.

Co-applicant, Dusan Hvolka's co-pending filing with Strong et al. entitled “Two Speed Gearbox”, U.S. Pat. No. 6,616,567 dated Sep. 9, 2003 discloses a two speed planetary gearbox activated by inboard and outboard clutches each associated with its own separate planetary gear system located and controlled in the wheel hub of the axle. In the low range, it employs a static clutch. In the high range it employs a dynamic clutch sealed with dynamic seals, which leak as the pressure increases; thereby requiring at high pressures a pump to remove excess fluids.

Phebus et al., U.S. Pat. No. 5,024,636 dated Aug. 18, 1991 discloses a two ratio planetary hub utilizes spring applied pressure release clutches between the sun gear and planet carrier and ring gear to stationary housing to provide selectable ratios, braking and neutral functions.

Cited for general interest is Bennett, U.S. Pat. No. 6,843,750 dated Jan. 18, 2005 disclosing a two speed gearbox with integrated differential employing a differential spider.

Other two speed shiftable gearboxes have short bearing lives when the two speed gearbox is operated for long periods of time in high range. This is because there is a large thrust load on the thrust bearing between the High Range Apply Piston and the High Clutch. All applications will be torque limited in the high range due to the limitations of the input horsepower. This results in a lower required input torque as the input speed to the box increases. Since the required thrust load through the bearing is directly proportional to the torque, and since the life of the bearing is a function of the thrust load, an increase bearing life will result from reducing the thrust load on the bearing.

Two speed shiftable gearboxes employing hydraulic systems with clutch plates also encounter losses from pumps, friction plates, hydraulic and cooling systems. The invention described below provides a direct drive electric shift two speed planetary gearbox providing significant fuel efficiency as it does not employ hydraulic systems.

### SUMMARY OF THE INVENTION

As shown in the attached figures, the invention comprises a direct drive electric shift two speed planetary gearbox using similar planetary gearing as applicant's co-pending two speed gearbox, but omits the hydraulically activated clutch plates and substitutes instead a linear actuator shown as an electronic rotary actuator. It consists of a housing to which a housing spline ring is firmly connected, a LH flange with bearings on which a carrier assembly, containing a plurality of planet gears, is mounted, a RH flange with bearings on which an input shaft with sun gear is mounted, a ring gear with outer splines on which a shift coupling is mounted, and a shifting mechanism containing a shift fork pushed by an electric linear actuator either to the left side or to the right side. The linear actuator is mounted to the housing and adapted to selectively engage/disengage and lock the ring gear with the housing in a low speed mode, or, with a carrier assembly in a high speed mode. In a neutral mode the linear actuator positions the shift coupling midway between the carrier assembly and the housing releasing the ring gear from locking to either or both the components. Direct drive activation via an engaging/disengaging linear actuator avoids losses from hydraulic pumps, cooling systems, clutch plates, activation means, is resulting in fuel efficiency savings of 15-20% over comparable hydraulic drive systems. The direct drive electric shift two speed planetary gearbox thus provides an improved two speed gear box with significantly improved operating performance.

The direct drive electric shift two speed planetary gearbox may be associated with a drive axle driven by an hydrostatic drive system or it could be adapted for use with combustion and electric motors. In one preferred embodiment, the direct drive electric shift two speed planetary gear box contains a gear box housing encasing a carrier assembly, a sun gear with input shaft, a ring gear, and a shifting mechanism consisting of shift coupling, shift fork, an electric rotary actuator driving a power screw.

The gear box housing preferably has a generally cylindrical interior surface encasing the carrier assembly, which holds the planet gears to be engaged selectively by the linear actuator. The two speed planetary gearbox carrier assembly has a plurality of planet gears operatively connected to the sun gear of the planetary gear assembly, such that the sun gear rotates about a drive axis in conjunction with the gear carrier of the planetary gear assembly.

In a low speed mode, the shift coupling is moved by the shifting mechanism to its right hand end position locking the ring gear firmly to the housing spline ring of the gear box housing. Thus secured, each of the planet gears rotates about its own rotational axis and simultaneously also about the sun gear axis to transmit torque and to provide a low speed rotation of an output shaft.

When the shift coupling is moved by the shifting mechanism to a mid position, the ring gear, planet gears, and carrier assembly rotate freely in a neutral mode without transmitting any torque.

When the shifting mechanism moves the shift coupling to its left hand end position, it locks firmly the ring gear with the carrier spline ring to the carrier assembly. A result of such an arrangement is that the planet gears cannot rotate about their own axes (as their rotation is blocked since the ring gear is locked to the carrier assembly) causing the carrier assembly to rotate together with the ring gear and the sun gear at the same speed transmitting output torque equal to the input torque.

The ring gear of the planetary gear assembly forms a portion of the carrier assembly and provides a two speed gear box with a gear ratio of between approximately 1.8 to 10, when a single planetary gear assembly carrier is employed and is driven by the outputs provided by its planet gears.

For higher gear ratios greater than 3, instead of relying solely on the output generated by a single set of planet gears, the two speed gear box may include a carrier mount with a dual segmented planetary gear assembly adapted to rotate within the ring gear in a similar fashion to the single planetary gear assembly. Said carrier mount would include dual planet gears having differing gear segments, each with differing gear ratios, which are then selectively activated and driven by the sun gear to provide the desired output gear ratio. This dual planetary gear higher gear ratio segment, when activated, provides a gear ratio from 3 to 10. The dual planetary gear lower gear ratio segment, when activated, provides a gear ratio between 1.2 and 3.

The direct drive electric shift two speed planetary gearbox may be adapted to either reduce or increase outputs by reversing the gearbox input and output ends via universal end plate coupling structure adapted to attach to either end of the gearbox assembly or to the input drive shaft. These couplings are preferably splined to accommodate splined input and output shafts to prevent slippage. Thus adapted, either an increasing or decreasing torque output is provided by the two speed gearbox.

In the low range, the ring gear is locked to the gear box housing. This provides a speed reduction of approximately 1.8 to 10 in the preferred embodiment from input to output through the planetary gear sets. When conditions are favorable, the linear actuator shifts the shift coupling to the high speed mode. This locks up the planetary system so torque is transferred directly from the input sun gear/shaft to the carrier assembly and thus to the output shaft.

In summary, the direct drive electric shift two speed planetary gearbox connects to an axle operatively driven by a torque source associated with its sun gear of a central planetary gearing system via coupling means. Means for shifting from the low gear speed mode to a high speed mode are included via selective application of a linear actuator to lock either the ring gear to the housing, or, to the carrier assembly of the planetary gearbox to provide a plurality of geared outputs relative to the torque inputs.

### DESCRIPTION OF THE DRAWINGS

FIG. 1 is a side cross sectional view of the direct drive electric shift two speed planetary gearbox in a low speed mode.

FIG. 2 is a side cross sectional view of the embodiment shown in FIG. 1 in a neutral mode.

FIG. 3 is a side cross sectional view of the embodiment shown in FIG. 1 in a high speed mode.

FIG. 4 is an exploded view of the embodiment shown in FIG. 1.

### DESCRIPTION OF THE ILLUSTRATED EMBODIMENTS

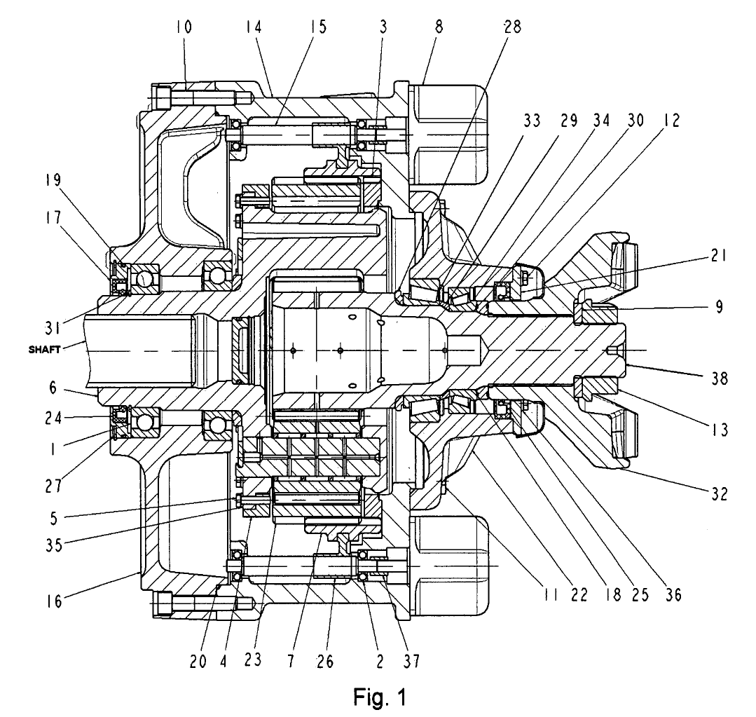

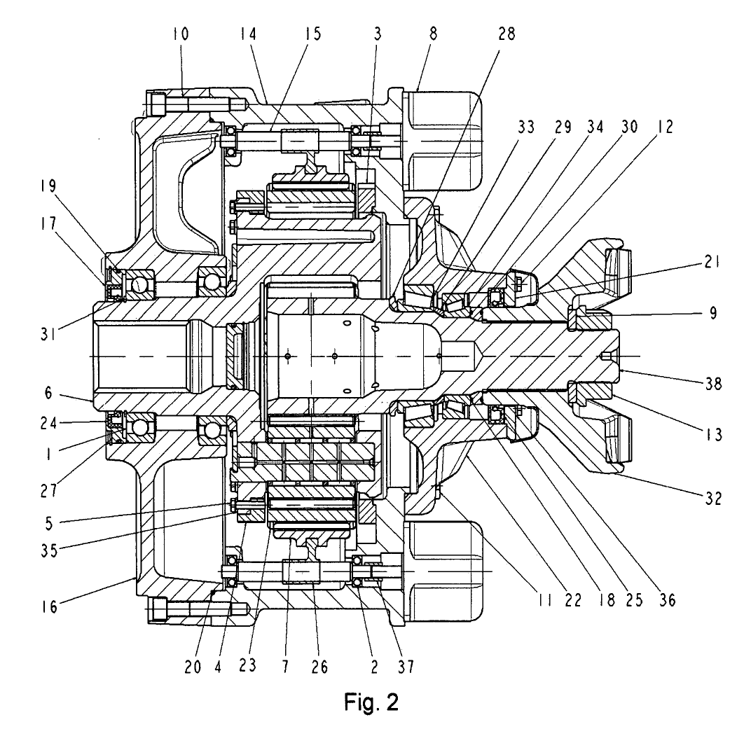

FIG. 1 is side cross sectional view of an assembled preferred embodiment of the direct drive electric shift two speed planetary gearbox of the present invention. The direct drive electric shift two speed planetary gearbox is for use with any device that receives a torque input and provides a torque output usually under high speeds and high temperature operating conditions. The following is the list of parts of the preferred embodiment shown in FIGS. 1, 2,3, and 4:
1) Ball Bearing
2) Ball Bearing
3) Housing Spline Ring
4) Carrier Spline Ring
5) Cap Screw
6) Carrier Assembly
7) Shift Coupling
8) Electronic Rotary Actuator
9) Hardened Washer
10) Hexagon Socket Cap Screw
11) Hexagon Head Bolt
12) Hexagon Head Bolt
13) Yoke Nut
14) Gear Box Housing
15) Power Screw
16) Flange, L.H
17) Cover, L.H.
18) O-Ring
19) O-Ring
20) O-Ring
21) Cover, FH.
22) Flange, R.H.
23) Ring Gear
24) Shaft Seal
25) Shaft Seal
26) Shift Fork
27) Spiral Retaining Ring
28) Spacer
29) Spacer
30) Spacer
31) Spiral Retaining Ring
32) Yoke
33) Tapered Roller Bearing
34) Tapered Roller Bearing
35) Washer
36) Washer
37) Spline Coupling
38) Sun Gear
39) Hexagon Socket Cap Screw
40) Washer
41) Breather Valve
42) Internal filter
43) Planet Gear

FIG. 1 shows the components of the direct drive electric shift two speed planetary gearbox in the low speed mode. The direct drive electric shift two speed planetary gear box contains a carrier assembly 6, a sun gear with input shaft 38, a ring gear 23 and a shifting mechanism consisting of shift coupling 7, shift fork 26, an electric rotary actuator 8 driving a power screw 15. In the low speed mode the shift coupling 7 is moved by the shifting mechanism to its right hand end position locking thus the ring gear 23 with the housing spline ring 3 firmly to the gear box housing 14. Thus secured, each of the planet gears 44 rotates about its own rotational axis and simultaneously also about the sun gear 38 axis to transmit torque and to provide a low speed rotation of an output shaft.

When the shift coupling 7 is moved by the shifting mechanism to a mid position shown on the FIG. 2, the ring gear 23, planet gears 44 and carrier assembly 6 rotate freely in a neutral mode without transmitting any torque.

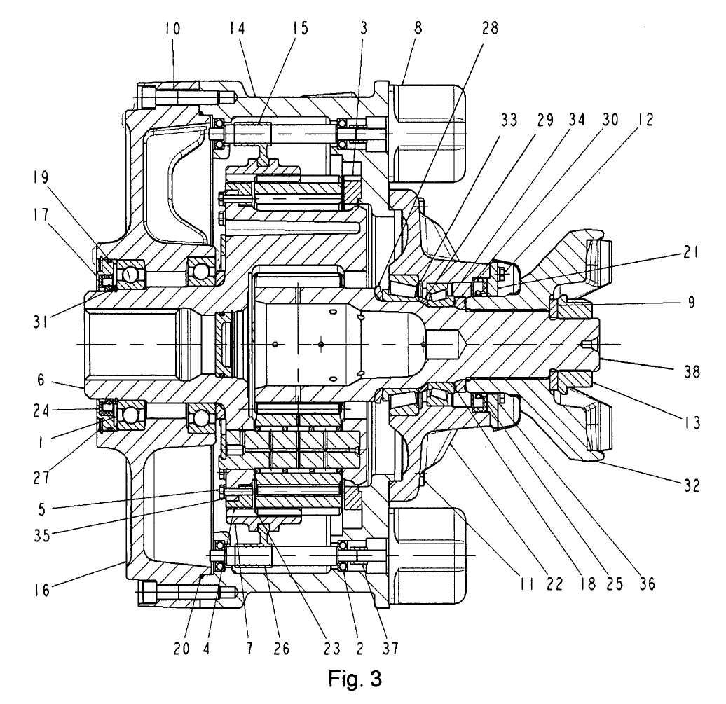

When the shifting mechanism moves the shift coupling 7 to its left hand end position, it locks the ring gear 23 with the carrier spline ring 4 firmly assembled to the carrier assembly 6 as shown on the FIG. 3. A result of such an arrangement is that the planet gears 43 cannot rotate about their own axes (as their rotation is blocked by the fact that the ring gear 23 is locked to the carrier assembly 6) causing the carrier assembly 6 to rotate together with the ring gear 23 and the sun gear 38 at the same speed transmitting thus the output torque equal to the input torque.

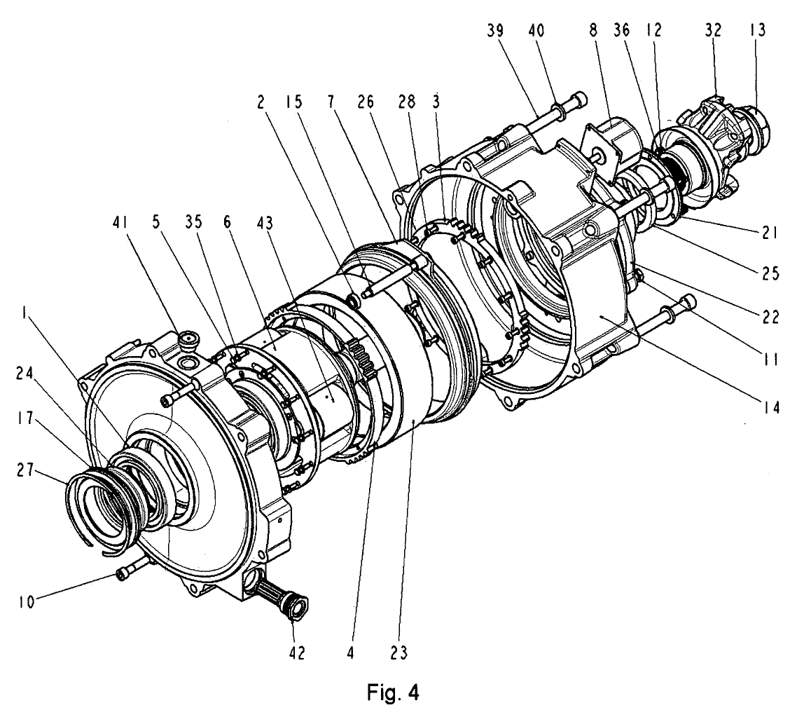

FIG. 4 is an exploded view of the embodiment shown in FIG. 1 showing the positioning of the various components. Starting at the left of the drawing, a spiral retaining ring 27 and shaft seal 24 and a ball bearing 1 secure about a shaft fitting within an opening in the cover L.H. 17. An internal filter 42 is inserted within the cover L.H. 17 as shown. The cover L.H. also has a breather valve 41. Hexagon socket cap screws 39 with washers 40 secure the cover L.H. 17 to the gear box housing 14 and cover R.H. 21 forming a housing which surrounds the carrier assembly 6 containing planetary gears 43 associated with a ring gear 23 and sun gear 38. These components are selectively activated by an electronic rotary actuator 8 mounted on the cover, R.H. 21 to move the shift coupling 7, which moves laterally a shift fork 26 to activate the appropriate gears.

Other components shown are a housing spline ring 3, a carrier spline ring, 4 and various 0-rings 18, 19, and 20. A spline coupling 37 with washers 35,36, and shaft seals, 24,25, are associated with the yoke 32 attached to the cover, R.H. 21 via a yoke nut 13 to allow rotation of the output drive line yoke 32 in response to the action of the planetary gears 43. These major components are associated with ball bearings 2, hardened washer 9, hexagon socket cap screw 10, hexagon head bolts 11, 12, power screw 15, flange L.H. 16, flange R.H. 22, spacers 28, 29, 30, spiral retaining ring 31, tapered roller bearings 33, 34, as shown.

The foregoing description of the illustrated embodiments is not intended to limit the scope of the appended claims. The claims themselves recite those features deemed essential to the invention.

We claim:

1. A direct drive electronic shaft two speed planetary gearbox comprising:
a. a gearbox housing with first and second ends and a cylindrical internal surface with an internal spline ring adapted to selectively engage a ring gear,
b. a rotatable input coupling associated with a first end of the gearbox housing to connect to an input drive,
c. an output coupling associated with the second end of the gearbox housing to connect to an output drive,
d. a carrier assembly rotatably mounted within the gearbox housing with
i. a sun gear associated with the input coupling to be driven by the input drive,
ii. a plurality of planet gears meshed with the sun gear,
iii. a ring gear operably associated with and interconnecting the planet gears; said ring gear structured to selectively engage/disengage the spline ring of the gearbox housing so that the output coupling generates output drive;
e. an engaging/disengaging linear actuator located on the gear gearbox housing adapted to longitudinally extend and retract to selectively engage and lock the ring gear to the spline ring of the gearbox housing when positioned at one extreme in a low speed mode; to reverse and extend in the opposite extreme direction to selectively engage the sun gear and disengage the ring gear from the spline ring in a high speed mode, and to shift in a mid position so that the ring gear, planet gears, and carrier assembly rotate freely when the linear actuator is positioned therebetween in a neutral mode; and
f. activation means to selectively position the linear actuator to provide the desired operating speed mode.

2. The direct drive electronic shaft two speed planetary gearbox of claim 1, wherein the linear actuator comprises an electronic rotary actuator activated by an electric circuit.

3. The direct drive electronic shaft two speed planetary gearbox of claim 1, wherein at the linear actuator is adapted to be engaged and disengaged manually.

4. The direct drive electronic shaft two speed planetary gearbox of claim 1, wherein there is only one carrier assembly, which provides a gear ratio greater than 1.8 to a high ratio in excess of 10.

5. The direct drive electronic shaft two speed planetary gearbox of claim 1, wherein the plurality of planet gears of the carrier assembly are operatively connected to the sun gear of the planetary gear assembly, such that the sun gear rotates about a drive axis in conjunction with the carrier assembly.

6. The direct drive electronic shaft two speed planetary gearbox of claim 1, wherein the carrier assembly includes an additional carrier assembly with sun gear, a plurality of planet gears, and a ring gear operably associated with one another and having their respective gears aligned such that the sun gear selectively engages desired components of the second additional carrier resulting in a ratio of 1.8 to 10 in high speed mode, and a gear ratio from 1.2 to 3 in a low speed mode.

7. The direct drive electronic shaft two speed planetary gearbox of claim 6, wherein the carrier assemblies have different gear ratios.

8. The direct drive electronic shaft two speed planetary gearbox of claim 1, wherein the input coupling and output coupling comprise universal coupling face plates adapted to connect either end of the gear box to the input drive to provide either an increasing or decreasing torque output to the output drive.

9. The direct drive electronic shaft two speed planetary gearbox of claim 8, wherein the output coupling of the two speed gearbox is an output yoke.
